(19) United States
(12) Patent Application Publication
(10) Pub. No.: US 2003/0024108 A1
(43) Pub. Date: Feb. 6, 2003

(54) Manufacturing device of support parts

(76) Inventors: Yoshikazu Tsujimoto, Osaka (JP); Tsuyoshi Inada, Osaka (JP)

Correspondence Address: JORDAN AND HAMBURG LLP, 122 East 42nd Street, New York, NY, 10168, US

(21) Appl. No.: 09/808,841

(22) Filed: Mar. 15, 2001

(51) Int. Cl. B23P 23/00

(52) U.S. Cl. 29/783; 29/785; 29/788; 29/792; 29/796; 29/564.1

(57) ABSTRACT

The invention provides a manufacturing device for improving working property and reducing the burden of a worker in manufacture of support parts. This manufacturing device has a conveying device for intermittently conveying a main body of the support parts respectively having a bearing press-fitting portion and a bolt press-fitting hole along a predetermined conveying path while the main body is temporarily stopped every constant conveying distance. Plural holding members for holding the main body in a constant posture every constant clearance in a conveying direction of the conveying device are arranged. One stopping position of the holding members in the conveying path is set to a supply setting portion of the main body. A bolt supply device for temporarily inserting a bolt into a bolt press-fitting hole of the main body, a bolt press-fitting device for press-fitting the bolt into the bolt press-fitting hole, a bearing press-fitting device for press-fitting a bearing into a bearing press-fitting portion on an axial one end side of the main body, and a caulking device for caulking an axial end portion of the bearing press-fitting portion so as to fix the bearing are arranged every stopping position of the holding members located on a front side from the position of the supply setting portion in the conveying direction. These devices are arranged to perform the respective operations in accordance with a temporary stopping action of the conveying device.

### BACKGROUND OF THE INVENTION

1. Field of the Invention

The present invention relates to a manufacturing device of support parts used in a front support of a vehicle, etc.

2. Description of the Related Art

For example, there is a strut mount having a structure as shown in FIGS. 10 and 11 as a support part used in a front support of a vehicle, etc. In this strut mount 1, a rubber elastic body 4 is arranged between an outside attachment fitting 2 having an attaching plate portion 2b projected outward from a sleeve-shaped portion 2a and an inside attachment fitting 3 having a sleeve shape, and is vulcanized and adhered to both the outside attachment fitting 2 and the inside attachment fitting 3. Plural bolts 6 for attachment are press-fitted and fixed to the attaching plate portion 2b of the outside attachment fitting 2. A bearing 8 is press-fitted into the inside attachment fitting 3.

The support part such as the strut mount having such a structure is manufactured by the following manufacturing processes.

(1) A main body is manufactured by vulcanization molding by joining an outside attachment fitting and an inside attachment fitting by a rubber elastic body interposed between these fittings.

(2) A bolt for attachment is inserted into each of plural bolt press-fitting holes formed in the outside attachment fitting of the main body.

(3) An inserted bolt press-fitting portion is press-fitted into each of the bolt press-fitting holes by a press machine, etc.

(4) A bearing is press-fitted into a bearing press-fitting portion arranged in the inside attachment fitting.

(5) An end portion of the bearing press-fitting portion of the inside attachment fitting is caulked so as to prevent falling off of the bearing.

Further, after the above processes, the support part is moved to a painting process, and is painted and dried.

An independent device is conventionally used every each of bolt press-fitting, bearing press-fitting, caulking fixation processes, etc. with respect to the main body of the support part after the vulcanization molding process. The main body is manually moved by a worker between the devices.

Therefore, it takes much time and labor to transfer and mount the support part main body to the device of each of the bolt press-fitting and the bearing press-fitting, and take out the support part main body from the device after the process, and transfer the support part main body to the next process. Accordingly, a problem exists in that working efficiency is low, and burden of the worker is large.

### SUMMARY OF THE INVENTION

An object of the invention is to provide a manufacturing device of support parts able to improve working efficiency of bolt press-fitting and bearing press-fitting processes in manufacture of the support parts, and reduce the burden of a worker.

To achieve the above object, the invention resides in a manufacturing device of support parts having conveying means for intermittently conveying a main body of plural support parts respectively having a bearing press-fitting portion and plural bolt press-fitting holes along a predetermined conveying path while the main body is temporarily stopped every constant conveying distance; the manufacturing device being characterized in that plural holding members for holding the main body in a constant posture every constant clearance in a conveying direction are arranged in the conveying means; and one stopping position of the holding members in the conveying path is set as a supply setting portion for supplying the main body to the holding members; and bolt supply means for supplying and partially inserting a bolt for attachment into a bolt press-fitting hole of the main body, bolt press-fitting means for press-fitting the supplied bolt into the bolt press-fitting hole until a predetermined position, bearing press-fitting means for press-fitting a bearing into a bearing press-fitting portion on an axial one end side of the main body after the bolt press-fitting, and caulking means for caulking an axial end portion of the bearing press-fitting portion press-fitting the bearing thereinto so as to fix the bearing are arranged every stopping position of the holding members located on a front side from a position of the supply setting portion in the conveying direction; and the means are set to perform the respective operations in accordance with a temporary stopping action of the conveying means.

In accordance with this manufacturing device, the main body of the plural support parts respectively having the bearing press-fitting portion and the plural bolt press-fitting holes is supplied to the holding member arranged in the conveying means during temporary stoppage of the conveying means. The main body is then held in a constant posture and is intermittently conveyed while the main body is temporarily stopped along the predetermined conveying path every constant conveying distance.

The bolt inserting means, the bolt press-fitting means, the bearing press-fitting means and the caulking means are sequentially arranged every stopping position of the holding member on the front side of this conveying device in the conveying direction. Accordingly, in each stopping position, for example, a bolt for attachment is temporarily inserted into the bolt press-fitting hole of the main body by the bolt inserting means. In the next stopping position, the inserted bolt is perfectly press-fitted into the bolt press-fitting hole by the press-fitting means. In the next stopping position, the bearing is press-fitted by the bearing press-fitting means into the bearing press-fitting portion of the main body into which the above bolt is press-fitted. Further, in the next stopping position, the axial end portion of the bearing press-fitting portion press-fitting the bearing thereinto is caulked by the caulking means so as to fix the bearing.

Thus, in accordance with the manufacturing device of the support parts in the invention, at least bolt insertion, bolt press-fitting, bearing press-fitting and caulking processes are respectively sequentially performed with respect to the main body of the plural support parts intermittently conveyed by the conveying means.

Thus, manufacture of the support parts, particularly, the works of bolt press-fitting and bearing press-fitting processes after a vulcanization molding process are efficiently made, and transferring and setting works between the processes can be saved so that working property can be improved and the working burden of a worker can be reduced.

The conveying means is preferably constructed by a turntable intermittently rotated every constant angle, and the holding members for holding the main body of the support parts are preferably arranged in plural positions every equal angle corresponding to the constant angle on the turntable. Thus, an arranging space of the entire manufacturing device can be reduced, and a moving range of the worker making a supply setting work of the main body to the conveying means can be set to be narrow so that the working property can be further improved.

In the manufacturing device of the support parts, bearing supply means for supplying the bearing to an opening portion of the bearing press-fitting portion of the main body is preferably arranged in the stopping position of the holding members from the position of the supply setting portion to an arranging position of the bearing press-fitting means on the front side in the conveying direction. Thus, a supply work of the bearing can be automated and the number of works of the worker can be further reduced.

Further, in the invention, painting means for painting the processed product, and drying means for drying the painted product can be arranged after a caulking process using the caulking means. Thus, the product after the above working processes can be efficiently painted and dried.

The painting means and the drying means are preferably arranged within the conveying path for conveying the support parts by conveying means different from the conveying means. Thus, the painting means and the drying means can be easily arranged with good working efficiency.

### BRIEF DESCRIPTION OF THE DRAWINGS

FIG. 1 is a plan view schematically showing a manufacturing device of a strut mount fitting in one embodiment of the invention.

FIG. 2 is a front view schematically showing the manufacturing device.

FIG. 3 is an enlarged sectional view of one portion of a bearing supply process with respect to a holding member of a main body of a support part on a conveying means.

FIG. 4 is a plan view of the holding member.

FIG. 5 is a front view of a bolt supply means.

FIG. 6 is an enlarged sectional view of one portion of a bolt supply process.

FIG. 7 is an enlarged sectional view of one portion of a bolt press-fitting process.

FIG. 8 is an enlarged sectional view of one portion of a bearing press-fitting process.

FIG. 9 is an enlarged sectional view of one portion of a caulking process.

FIG. 10 is a perspective view showing a strut mount as one example of the support part.

FIG. 11 is a sectional view of the strut mount.

### DESCRIPTION OF THE PREFERRED EMBODIMENTS

One embodiment of a manufacturing device of support parts of the present invention will next be explained with reference to the drawings.

In this embodiment, the explanation is made with respect to a device for manufacturing a strut mount as one support part, particularly, a device for manufacturing the strut mount as a final product by performing processings such as bolt press-fitting, bearing press-fitting and caulking fixation with respect to a main body after a vulcanization molding process.

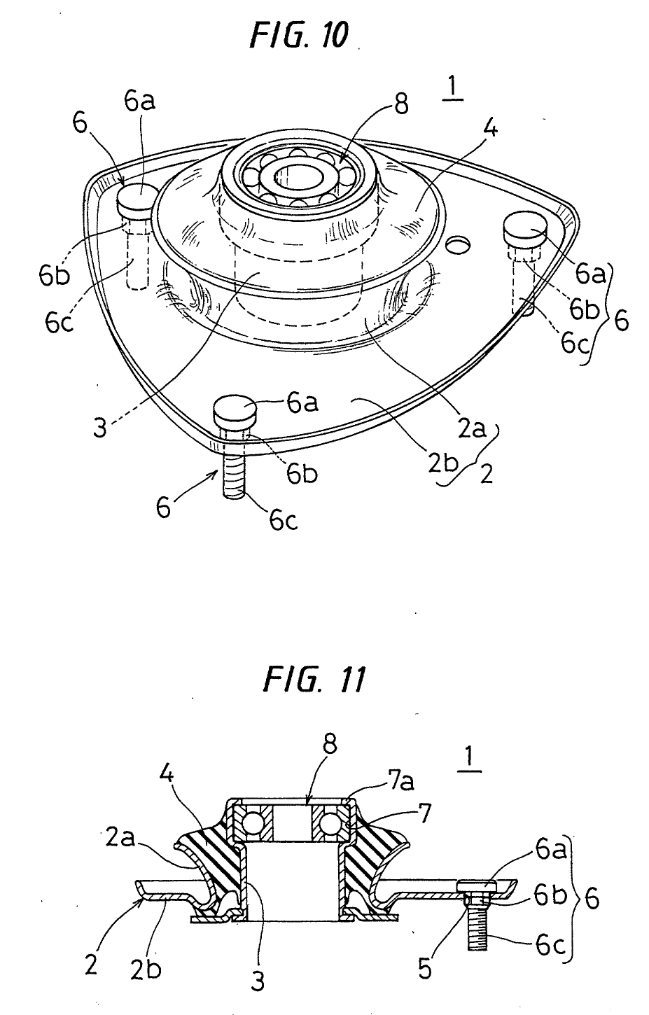

The strut mount 1 as a manufacture object has a structure shown in FIG. 10. A rubber elastic body 4 is arranged between an inside attachment fitting 3 having a sleeve shape and an outside attachment fitting 2 having an attaching plate portion 2b continuously connected from a sleeve-shaped portion 2a having a horn shape and projected outward, and is vulcanized and adhered to both these fittings 2 and 3. Plural bolt press-fitting holes 5 are formed in the attaching plate portion 2b of the outside attachment fitting 2 and are spaced from each other in a circumferential direction. A bolt 6 for attachment is press-fitted into each bolt press-fitting hole 5 as described later.

The bolt 6 for attachment has a head portion 6a, a first shaft portion 6b connected to the head portion 6a, and a second shaft portion 6c connected to the first shaft portion 6b. A screw is formed in the second shaft portion 6c. A diameter of the first shaft portion 6b is set to be slightly larger than that of the bolt press-fitting hole 5 such that the first shaft portion 6b can be press-fitted into the bolt press-fitting hole 5. This first shaft portion 6b is preferably knurled along an axial direction.

One end side of the inside attachment fitting 3 in its axial direction is diametrically enlarged as a bearing press-fitting portion 7, and a bearing 8 is press-fitted into this bearing press-fitting portion 7 as described later.

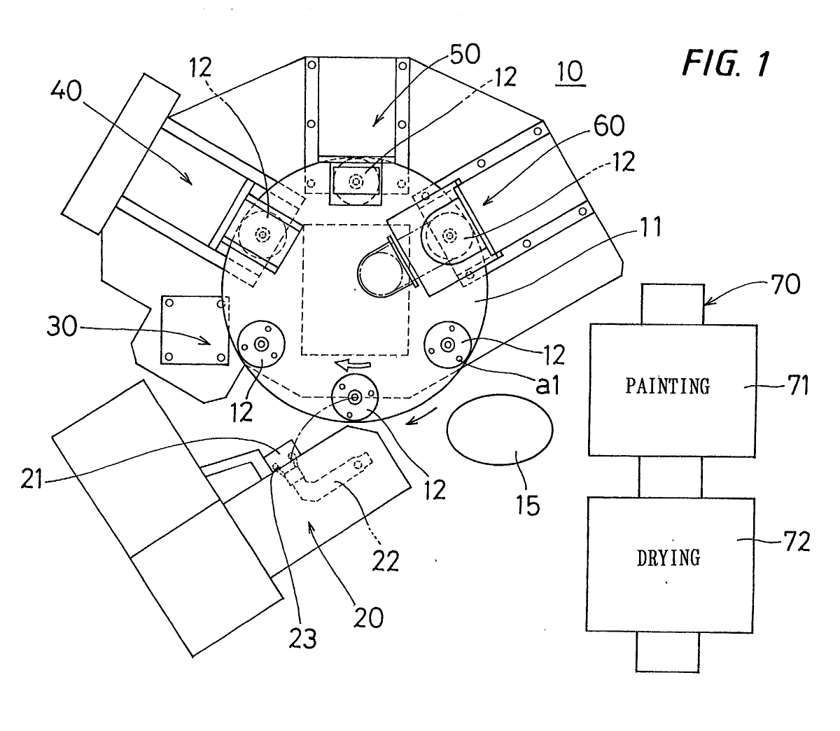

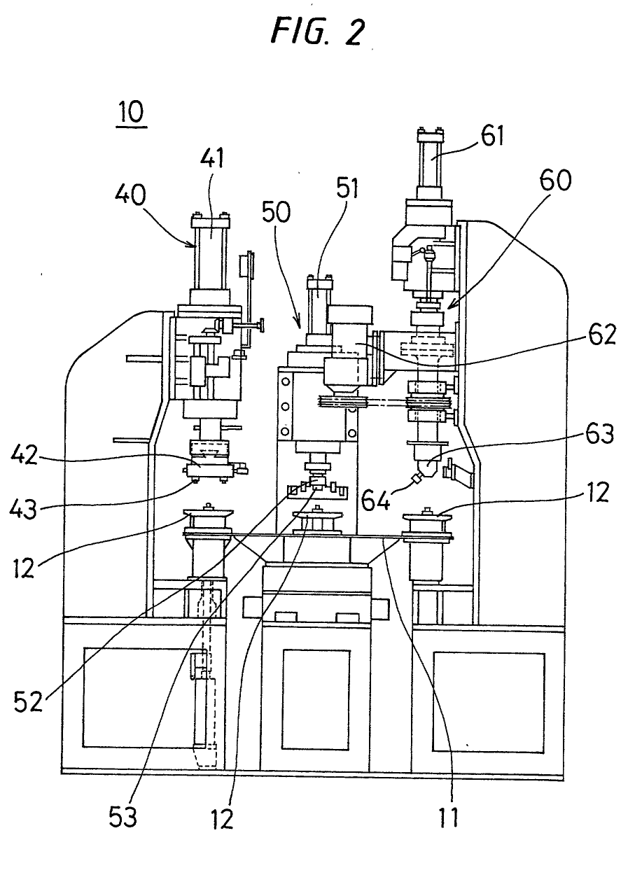

The manufacturing device 10 shown in FIGS. 1 and 2 manufactures a strut mount 1 having the above construction as a final product by performing processings such as bolt-press-fitting, bearing press-fitting and caulking fixation with respect to a bolt obtained by joining the outside attachment fitting 2 and the inside attachment fitting 3 by the rubber elastic body 4 interposed by vulcanization molding between these fittings, and a main body 1A before the bearing press-fitting. This manufacturing device 10 has the following construction.

This manufacturing device 10 has a turntable 11 as a conveying means for intermittently conveying the main body 1A while the main body 1A is temporarily stopped along a predetermined conveying path every constant distance. For example, the turntable 11 is intermittently rotated every constant angle such as 60°. A holding member 12 for holding the main body 1A in a constant posture is arranged in this turntable 11 at a constant interval in a circumferential direction as a conveying direction, i.e., in plural positions every equal angle (e.g., 60°) corresponding to the above constant angle. This holding member 12 can hold the main body 1A such that the bearing press-fitting portion 7 on one end side of the main body 1A in its axial direction is opened upward. In this holding state, a through hole 13 is formed in a position corresponding to the bolt press-fitting hole 5 formed in the outside attachment fitting 2.

One stopping position of the holding member 12 in a conveying path using the turntable 11 is set as a supply setting portion for supplying the main body 1A to the holding member 12. Namely, in a position a1 of this supply setting portion, the main body 1A sent from a vulcanization molding process and stored can be supplied and set to the holding member 12 in a conveyance stopping state. This supply setting work is made by a worker 15. The position a1 of this supply setting portion is also a collecting position of a processed product described later.

Each of the following means is arranged in the stopping position of each holding member 12 located on a front side in the conveying direction from the above position of the supply setting portion.

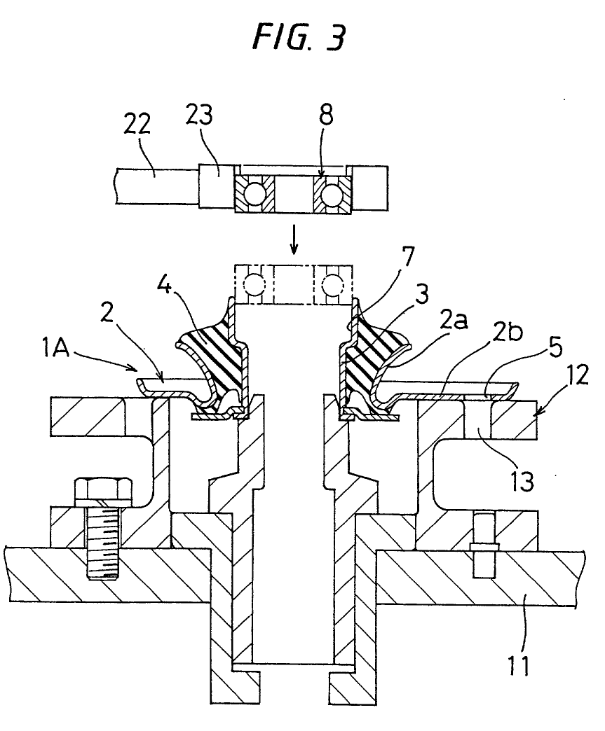

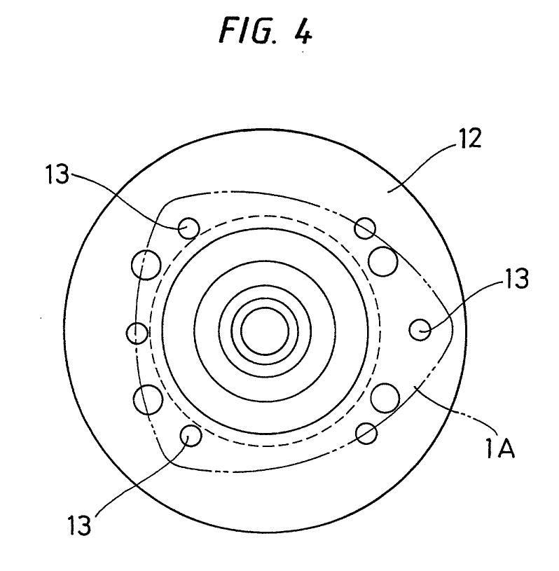

First, a bearing supply means 20 is arranged in the vicinity of the turntable 11 in a stopping position of the next holding member 12 to the position a1 of the supply setting portion. This bearing supply means 20 has a chuck type arm 22 rotated between a bearing supply port portion 21 and the stopping position of the holding member 12. As shown in FIG. 3, this arm 22 is operated in accordance with a conveyance stopping action of the main body 1A held and conveyed by the holding member 12. The bearing 8 is gripped, rotated and transferred by a chuck portion 23 at a tip of the chuck 22. The arm 22 can supply the bearing 8 to an opening portion of the bearing press-fitting portion 7 opened upward in the main body 1A, and can temporarily mount the bearing 8 to this opening portion. This temporary mounting work of the bearing 8 may be also made by the worker 15 together with a supply set work of the main body 1A onto the holding member 12. The bearing 8 may be also supplied and set in the position of a bearing press-fitting means described later although this construction is not illustrated.

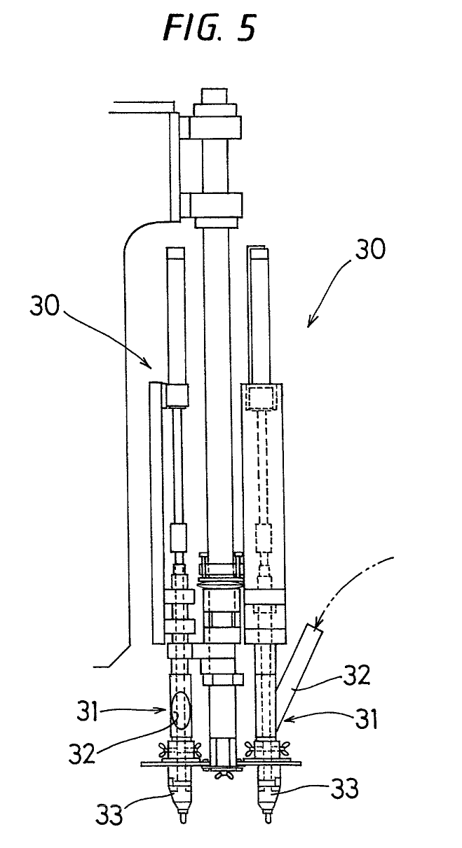

A bolt supply means 30 for supplying the bolt 6 for attachment to each of the plural bolt press-fitting holes 5 of the main body 1A is arranged in the vicinity of the turntable 11 in a stopping position of the next holding member 12. As shown in FIG. 5, for example, this bolt supply means 30 is constructed by a guide portion 32, a bolt holding portion 33 and an unillustrated pressing means of a piston type, etc. The guide portion 32 is connected to one side of a forked hollow tube 31 supported so as to be raised and lowered, and receives and guides the bolt 6 for attachment sent from a bolt conveying mechanism. The bolt holding portion 33 has an unillustrated chuck means therein, and holds the bolt 6 sent through this guide portion 32. The pressing means is arranged on the other side of the forked hollow tube 31, and pushes out the bolt 6 held by the bolt holding portion 33 downward. The bolt supply means 30 is arranged in an upward position corresponding to each of the plural bolt press-fitting holes 5 of the main body 1A in a stopping state. Reference numeral 34 designates a cylinder for operating the pressing means.

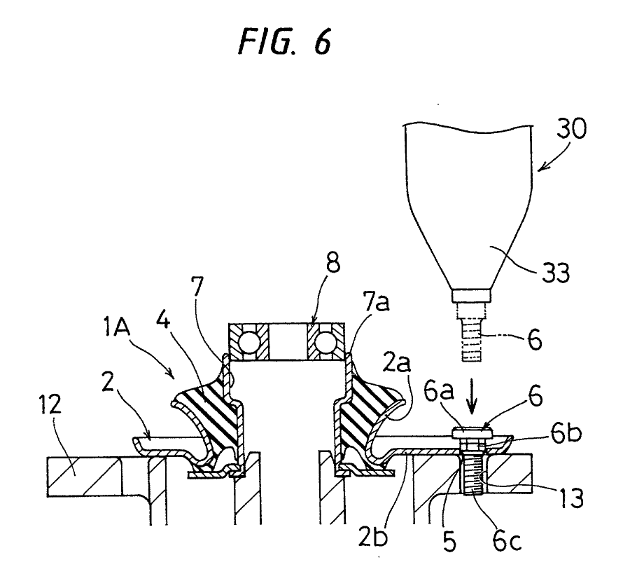

This bolt supply means 30 is operated in accordance with the conveyance stopping action of the main body 1A held and conveyed by the holding member 12. The bolt supply means 30 pushes out the bolt 6 for attachment held by the bolt holding portion 33 downward by the pressing means in a state in which the bolt supply means 30 is lowered so as to be close to a position above the bolt press-fitting hole 5 of the main body 1A in the stopping state. As shown in FIG. 6, one portion of this bolt 6, i.e., the second shaft portion 6c having a slight small diameter is inserted into the bolt press-fitting hole 5.

A bolt press-fitting means 40 is arranged in a stopping position of the next holding member 12 separated by a predetermined necessary distance from the above position. The bolt press-fitting means 40 press-fits the bolt 6 for attachment supplied, partially inserted and set to each of the plural bolt press-fitting holes 5 of the main body 1A into this bolt press-fitting hole 5 in the vicinity of the turntable 11. As shown in FIG. 2, in this bolt press-fitting means 40, an attaching member 42 raised and lowered is arranged above the above stopping position with e.g., a hydraulic cylinder as a driving source 41. A pressing body 43 is arranged in the attaching member 42 in a position corresponding to each bolt press-fitting hole 5 of the main body 1A.

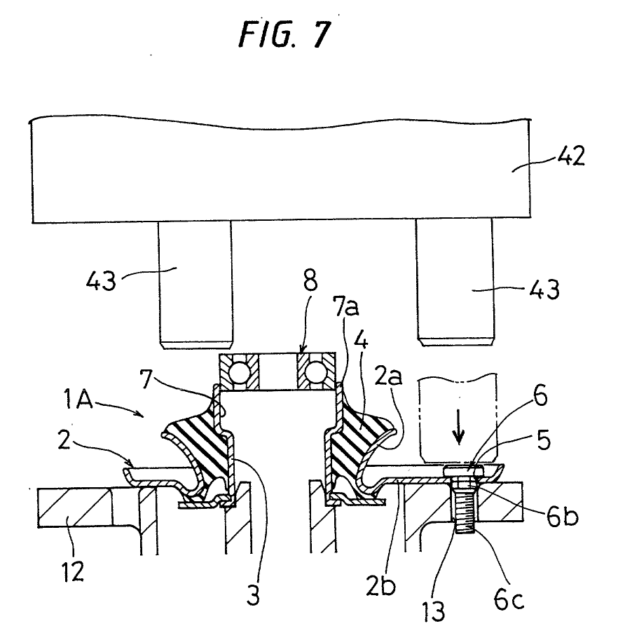

This bolt press-fitting means 40 is operated in accordance with the conveyance stopping action of the main body 1A held and conveyed by the holding member 12, and the attaching member 42 is lowered by the driving source 41 toward the turntable 11. Thus, as shown in FIG. 7, the pressing body 43 presses against the head portion 6a of the bolt 6 inserted and set to the bolt press-fitting hole 5, and press-fits a portion of the first shaft portion 6b of the bolt 6 into the bolt press-fitting hole 5.

Further, a bearing press-fitting means 50 is arranged in a stopping position of the next holding member 12 separated by a predetermined necessary distance from the above bolt press-fitting position. The bearing press-fitting means 50 press-fits the bearing 8 temporarily mounted to an opening portion of the bearing press-fitting portion 7 of the main body 1A into the bearing press-fitting portion 7 in the vicinity of the turntable 11.

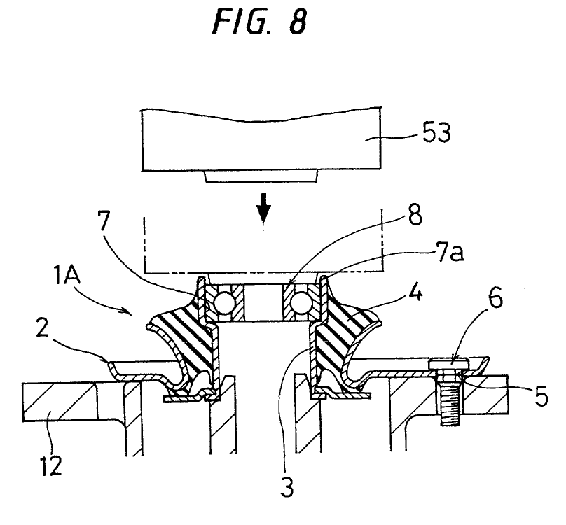

As shown in FIG. 2, for example, this bearing press-fitting means 50 has an attaching member 52 raised and lowered by a driving source 51 such as a hydraulic cylinder above the above stopping position. A pressing tool 53 is fixed to a lower face side of the attaching member 52, and has a shape approximately corresponding to an upper face of the main body 1A on the holding member 12. This bearing press-fitting means 50 is operated in accordance with the conveyance stopping action of the main body 1A held and conveyed by the holding member 12. The attaching member 52 is lowered toward the turntable 11 by the driving source 51 so that the bearing 8 temporarily mounted to the opening portion of the belt press-fitting hole 7 is pressed downward and is press-fitted into the belt press-fitting hole 7 as shown in FIG. 8.

Further, a caulking means 60 is arranged in a stopping position of the next holding member 12 separated by a predetermined necessary distance from the above bearing press-fitting position. The caulking means 60 inward caulks an axial end portion 7a of the bearing press-fitting portion 7 press-fitting the bearing 8 thereinto as mentioned above so as to fix the bearing 8 in the vicinity of the turntable 11.

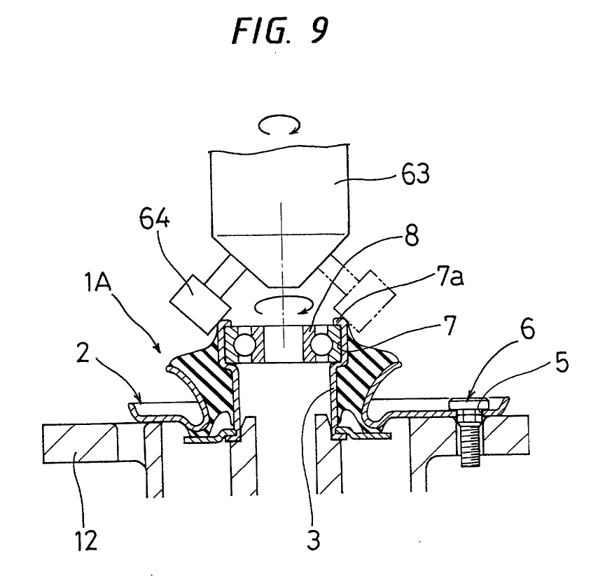

As shown in FIG. 2, for example, this caulking means 60 is raised and lowered by a driving source 61 such as a hydraulic cylinder in a position above the above stopping position, and a rotating support portion 63 rotated by a motor 62 is arranged. A pressing roller 64 having an axis inclined with respect to a rotating axis is attached to the rotating support portion 63. This caulking means 60 is operated in accordance with the conveyance stopping action of the main body 1A held and conveyed by the holding member 12. As shown in FIG. 9, the rotating support portion 63 is lowered by the driving source 61 toward the main body 1A in a downward position. The pressing roller 64 then comes in contact with the axial end portion 7a of the bearing press-fitting portion 7, and this end portion 7a is rotated in a pressing state. Thus, the end portion 7a is caulked so as to cover and fix an end face portion of an outer circumferential portion of the inside bearing 8. Thus, the bearing 8 press-fitted into the bearing press-fitting portion 7 can be fixed so as not to be detached therefrom.

The strut mount 1 as a product obtained by completing the above processings is further taken up and collected by the worker 15 from the holding member 12 on the turntable 11 in a stopping position of the next holding member 12 on the turntable 11, e.g., in the position a1 of the supply setting portion of the main body 1A as in the illustrated embodiment.

The product taken up and collected is placed and conveyed onto a conveyer 70 as a conveying means separated from the turntable 11 as it is, or is once stocked and is placed and conveyed onto this conveyer. Thus, while the product is conveyed by a painting means 71 arranged within the conveying path using the conveying means 70, predetermined painting such as rust prevention is performed with respect to the product, and the product is further dried by a subsequent drying means 72. Thus, the strut mount 1 shown in FIGS. 10 and 11 is obtained as a final product.

Thus, in accordance with the manufacturing device of this embodiment, the main body 1A is supplied and set to the holding member 12 on the turntable 11 intermittently rotated every predetermined necessary angle in the position a1 of the predetermined supply setting portion. Thus, while the main body 1A is intermittently conveyed every constant distance by the intermittent rotation of the turntable 11, each of bearing supply, bolt insertion, bolt press-fitting, bearing press-fitting and caulking fixation processes is sequentially automatically advanced in each stopping position of the holding member 12 set along the conveying direction.

Thus, manufacture of the strut mount 1, particularly, the works of bolt press-fitting and bearing press-fitting processes after a vulcanization molding process are efficiently made, and it is possible to save transferring and setting works between the processes so that working property can be improved and the working burden of a worker can be reduced.

In the above embodiment, the supply setting work of the main body 1A onto the turntable 11 is manually made by the worker 15, but can be also made by arranging an automatic device such as a robot.

In the above embodiment, the painting means 71 and the drying means 72 are arranged within the conveying path of the conveyer 70 separated from the turntable 11, but the invention is not limited to this arrangement. The product held on the turntable may be also painted and/or dried by arranging at least one of the painting means and the drying means in the vicinity of the turntable.

Further, a conveying means except for the illustrated turntable can be also utilized as the conveying means for intermittently conveying the main body every constant distance.

What is claimed is:

1. A manufacturing device of support parts having conveying means for intermittently conveying a main body of plural support parts respectively having a bearing press-fitting portion and plural bolt press-fitting holes along a predetermined conveying path while the main body is temporarily stopped every constant conveying distance;
the manufacturing device being characterized in that plural holding members for holding said main body in a constant posture every constant clearance in a conveying direction are arranged in said conveying means; and one stopping position of said holding members in the conveying path is set as a supply setting portion for supplying said main body to the holding members; and bolt supply means for supplying and partially inserting a bolt for attachment into a bolt press-fitting hole of said main body, bolt press-fitting means for press-fitting said supplied bolt into said bolt press-fitting hole until a predetermined position, bearing press-fitting means for press-fitting a bearing into a bearing press-fitting portion on an axial one end side of said main body after said bolt press-fitting, and caulking means for caulking an axial end portion of said bearing press-fitting portion press-fitting the bearing thereinto so as to fix the bearing are arranged every stopping position of the holding members located on a front side from a position of said supply setting portion in the conveying direction; and said means are set to perform said respective operations in accordance with a temporary stopping action of said conveying means.

2. A manufacturing device of support parts according to claim 1, wherein said conveying means is constructed by a turntable intermittently rotated every constant angle, and the holding members for holding said main body are arranged in plural positions every equal angle corresponding to said constant angle on the turntable.

3. A manufacturing device of support parts according to claim 1 or 2, wherein bearing supply means for supplying the bearing to an opening portion of the bearing press-fitting portion of said main body is arranged in the stopping position of the holding members from the position of said supply setting portion to an arranging position of said bearing press-fitting means on the front side in the conveying direction.

4. A manufacturing device of support parts according to claim 1 or 2, wherein painting means for painting the support parts, and drying means for drying the painted support parts are arranged after a caulking process using said caulking means.

5. A manufacturing device of support parts according to claim 4, wherein said painting means and said drying means are arranged within the conveying path for conveying the support parts by conveying means different from said conveying means.
